(19) United States
(12) Patent Application Publication
(10) Pub. No.: US 2013/0034975 A1
(43) Pub. Date: Feb. 7, 2013

(54) CONNECTOR AND STRUCTURE FOR CONNECTING CIRCUIT BOARD AND EXTERNAL CONNECTOR

(71) Applicants: Mikio YOSHIDA, Kariya-shi (JP); Masanori TSUZUKI, Kariya-shi (JP); Shingo ENAMI, Kariya-shi (JP); Yusuke KINOSHITA, Kariya-shi (JP)

(72) Inventors: Mikio YOSHIDA, Kariya-shi (JP); Masanori TSUZUKI, Kariya-shi (JP); Shingo ENAMI, Kariya-shi (JP); Yusuke KINOSHITA, Kariya-shi (JP)

(73) Assignee: KABUSHIKI KAISHA TOYOTA JIDOSHOKKI, Kariya-shi (JP)

(21) Appl. No.: 13/563,075

(22) Filed: Jul. 31, 2012

(30) Foreign Application Priority Data
Aug. 1, 2011 (JP) 2011-168527

(51) Int. Cl. H01R 12/00; H01R 13/02

(52) U.S. Cl. 439/78; 439/884

(57) ABSTRACT

A structure for connecting a circuit board and an external connector includes a lead and a stress dampening unit. The lead electrically connects the circuit board and the external connector. The external connector is fitted to and removed from the lead. The stress dampening unit dampens stress applied to the circuit board by the lead when the external connector is fitted to and removed from the lead.

### BACKGROUND OF THE INVENTION

The present invention relates to a structure for connecting a circuit board and an external connector and to a connector connected to an external connector.

Japanese Laid-Open Patent Publication No. 2006-344458 discloses a structure for connecting a wiring board (circuit board), which uses a surface mounting type electrical connector contact (lead), to a mated electrical connector (external connector). The contact of the surface mounting type electrical connector includes one end defining a bonding portion, which is bonded by solder to a contact pad of the wiring board, and another end defining a connecting portion, which contacts a contact of the mated electrical connector. The bonding portion is bonded by solder to the contact pad and the connecting portion is arranged in contact with the contact of the mated electrical connector. This electrically connects the wiring board and the mated electrical connector through the surface mounting type electrical connector contact.

In the structure of Japanese Laid-Open Patent Publication No. 2006-344458, when the mated electrical connector is fitted to and removed from the contact of the surface mounting type electrical connector, force acts on the contact. The force acting on the contact is applied as stress to the wiring board. This may damage the wiring board.

### SUMMARY OF THE INVENTION

The present invention provides a connector and a structure for connecting a circuit board and an external connector that dampen the stress applied to the circuit board through a lead when an external connector is fitted to and removed from the lead.

One aspect of the present invention is a structure for connecting a circuit board and an external connector. The structure includes a lead that electrically connects the circuit board and the external connector. The external connector is fitted to and removed from the lead. A stress dampening unit dampens stress applied to the circuit board by the lead when the external connector is fitted to and removed from the lead.

A further aspect of the present invention is a connector including a lead that electrically connects a circuit board and an external connector. The external connector is fitted to and removed from the lead. A connector coupler is connected with the external connector. A stress dampening unit dampens stress applied to the circuit board by the lead when the external connector is fitted to and removed from the lead.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a partially cut-away cross-sectional view showing an electric compressor according to a first embodiment of the present invention;

FIG. 1B is a partial enlarged cross-sectional view of FIG. 1A showing a lead;

FIG. 2A is an enlarged cross-sectional view of FIG. 1A showing solder applied to a circuit board;

FIG. 2B is an enlarged cross-sectional view showing a solder bonding surface of a second connection terminal portion arranged on the solder;

FIG. 2C is an enlarged cross-sectional view showing the solder bonding surface of the second connection terminal portion soldered to the circuit board through a reflow process;

FIG. 3 is a partially enlarged cross-sectional view showing a lead according to a second embodiment of the present invention;

FIG. 4 is an enlarged cross-sectional view showing a state prior to the sandwiching of a metal terminal of FIG. 3; FIG. 5 is a partially enlarged cross-sectional view showing a lead according to a third embodiment of the present invention;

FIG. 6 is a partially enlarged cross-sectional view showing a lead in a further embodiment;

FIG. 7 is a partially enlarged cross-sectional view showing a lead in another embodiment;

FIG. 8A is an enlarged cross-sectional view showing an insertion hole filled with solder;

FIG. 8B is an enlarged cross-sectional view showing a lead inserted into the insertion hole; and

FIG. 8C is an enlarged cross-sectional view showing the lead soldered to a circuit board through a reflow process.

### DETAILED DESCRIPTION OF THE INVENTION

### First Embodiment

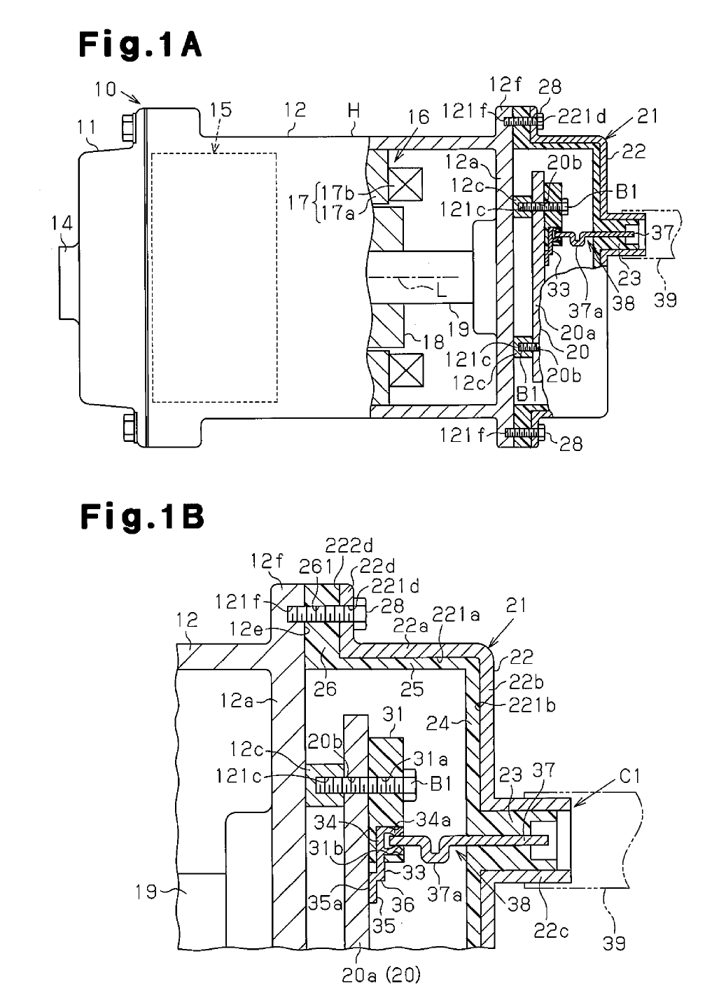

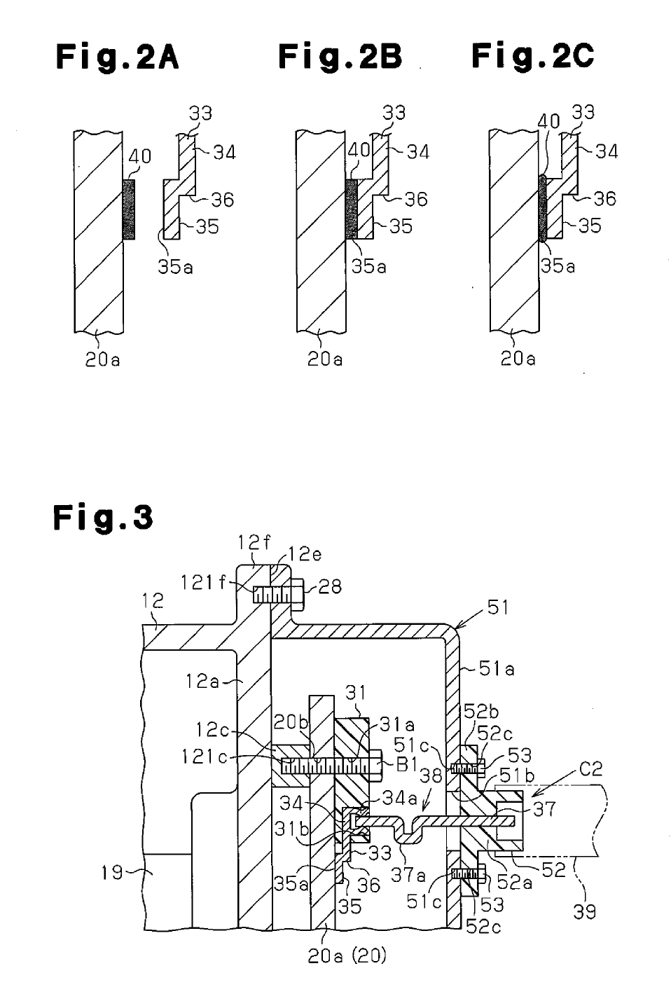

A first embodiment of the present invention will now be described with reference to FIGS. 1 and 2.

As shown in FIG. 1A, a housing H of an electric compressor 10 includes a cylindrical discharge housing 11, which is located at the left side as viewed in FIG. 1A, and a cylindrical suction housing 12, which is coupled with the discharge housing 11. Each of the discharge and suction housings 11 and 12 is formed from aluminum and includes a closed end. A suction port (not shown) is formed in a bottom wall of the suction housing 12 and connected to an external refrigerant circuit (not shown). A discharge port 14 is formed on the closed end (left side as viewed in FIG. 1A) of the discharge housing 11 and connected to the external refrigerant circuit.

The suction housing 12 accommodates a compression unit 15 (shown by broken lines in FIG. 1A), which compresses refrigerant, and an electric motor 16, which serves as a drive unit that drives the compression unit 15. In the present embodiment, although not shown in the drawings, the compression unit 15 includes a fixed scroll, which is fixed in the suction housing 12, and a movable scroll, which is arranged in a manner interleaved with the fixed scroll.

A stator 17 is fixed to an inner circumferential surface of the suction housing 12. The stator 17 includes a stator core 17a, which is fixed to the inner circumferential surface of the suction housing 12 and includes teeth (not shown), and a coil 17b, which is wound around the teeth of the stator core 17a. A rotary shaft 19, which extends through the stator 17, is rotatably supported by the suction housing 12. A rotor 18 is fixed to the rotary shaft 19.

A flange 12f extends outward from the circumferential wall of the suction housing 12 in a direction perpendicular to the axis L of the rotary shaft 19. The flange 12f extends around the entire circumferential wall and is continuous with an end wall 12a of the suction housing 12. The flange 12f includes a plurality of (two shown in FIG. 1A) threaded holes 121f. Two cylindrical supports 12c are arranged on an outer surface of the end wall 12a. Each support 12c includes a threaded hole 121c.

A circuit board 20a of an inverter 20 is arranged on the two supports 12c. The supports 12c support the circuit board 20a in a state separated from the end wall 12a. The circuit board 20a is arranged so that its mounting surface is orthogonal to the axial direction of the rotary shaft 19. A drive control circuit (i.e., inverter circuit) for the electric motor 16 is arranged on the circuit board 20a. Switching elements, filter coils, and capacitors (not shown) are also electrically connected to the circuit board 20a. The circuit board 20a includes two insertion holes 20b. A bolt B1 is inserted through each insertion hole 20b and fastened to the threaded hole 121c of the corresponding support 12c. This fixes the circuit board 20a to the supports 12c.

Referring to FIG. 1B, an inverter cover 21, which is open at one side, is fixed to the end wall 12a of the suction housing 12 to accommodate and cover the inverter 20 (circuit board 20a). The inverter cover 21 includes a metal cover 22, which is formed form aluminum and serves as a frame of the inverter cover 21. The metal cover 22 includes a tubular portion 22a and an end portion 22b. The tubular portion 22a is cylindrical and extends in the axial direction of the rotary shaft 19. The end portion 22b extends inward in a direction perpendicular to the direction in which the tubular portion 22a extends from the end of the tubular portion 22a facing away from the suction housing 12. The metal cover 22 includes a cylindrical connector coupler 22c, which is continuous with the end portion 22b and extends in the axial direction of the rotary shaft 19.

The metal cover 22 also includes an annular metal cover flange 22d, which extends outward perpendicular to the direction in which the tubular portion 22a extends from the end of the tubular portion 22a facing toward the suction housing 12. The metal cover flange 22d includes insertion holes 221d aligned with the threaded holes 121f of the flange 12f. The metal cover 22 is arranged to encompass the circuit board 20a.

The connector coupler 22c accommodates a resin holder 23, which is arranged integrally with the connector coupler 22c. An inner end insulator 24, which is formed from a resin, is arranged integrally with the metal cover 22 on an inner surface 221b of the end portion 22b. The inner end insulator 24 extends continuously from the holder 23 along the inner surface 221b of the end portion 22b. An inner circumferential insulator 25, which is formed from a resin, is arranged integrally with the metal cover 22 on an inner surface 221a of the tubular portion 22a. The inner circumferential insulator 25 extends continuously from the inner end insulator 24 along the inner surface 221a of the tubular portion 22a.

A seal flange 26, which is formed from a resin, is arranged integrally with the metal cover 22 on an end surface 222d of the metal cover flange 22d. The seal flange 26 extends continuously from the inner circumferential insulator 25 at the end facing toward the suction housing 12 along the end surface 222d of the metal cover flange 22d. The seal flange 26 includes insertion holes 261 aligned with the threaded holes 121f of the flange 12f and the insertion holes 221d of the metal cover flange 22d. In the present embodiment, the metal cover 22, the holder 23, the inner end insulator 24, the inner circumferential insulator 25, and the seal flange 26 form the inverter cover 21.

Bolts 28 are inserted through the insertion holes 221d of the metal cover flange 22d and the insertion holes 261 of the seal flange 26 and fastened to the threaded holes 121f of the flange 12f to fix the inverter cover 21 to the end wall 12a of the suction housing 12. The seal flange 26, which is arranged between the metal cover flange 22d and the flange 12f, hermetically seals the gap between the end surface 222d of the metal cover flange 22d and an end surface 12e of the flange 12f.

The circuit board 20a includes a front surface (first surface) and a rear surface (second surface). A resin connector 31 is coupled to the front surface. The resin connector 31 includes an insertion hole 31a. A bolt B1 is inserted through the insertion hole 31a of the resin connector 31 and one of the insertion holes 20b of the circuit board 20a and fastened to the threaded hole 121c of the corresponding support 12c. This fixes the resin connector 31 to the front surface of the circuit board 20a.

The resin connector 31 includes a connection terminal 33. The connection terminal 33 includes a first connection terminal portion 34, which extends parallel to the front surface of the circuit board 20a and is mostly embedded in the resin connector 31. The first connection terminal portion 34 includes one end (distal end) defining a connecting portion 34a and another end (basal end) projecting out of the resin connector 31. The resin connector 31 includes an accommodation recess 31b that accommodates the connecting portion 34a.

Further, the connection terminal 33 includes a second connection terminal portion 35, which is continuous with the basal end of the first connection terminal portion 34 and extends parallel to the front surface of the circuit board 20a. A step 36 is formed between the first connection terminal portion 34 and the second connection terminal portion 35. The second connection terminal portion 35 is located closer to the circuit board 20a than the first connection terminal portion 34. The second connection terminal portion 35 includes a surface facing toward the circuit board 20a that defines a solder bonding surface 35a (solder bonding portion), which solders the circuit board 20a and the second connection terminal portion 35. A reflow process is performed to solder the circuit board 20a and the solder bonding surface 35a of the second connection terminal portion 35.

Referring to FIG. 2A, to solder the circuit board 20a and the solder bonding surface 35a of the second connection terminal portion 35 in the reflow process, a paste of solder 40 is first applied to the front surface of the circuit board 20a. Then, referring to FIG. 2B, the solder bonding surface 35a of the second connection terminal portion 35 is placed on the solder 40. Subsequently, the circuit board 20a is arranged in a reflow furnace and heated to a maximum temperature of approximately 260° C. This solders the circuit board 20a and the solder bonding surface 35a of the second connection terminal portion 35, as shown in FIG. 2C. In this manner, the circuit board 20a and the second connection terminal portion 35 are electrically connected by soldering the circuit board 20a and the solder bonding surface 35a of the second connection terminal portion 35.

Referring to FIG. 1B, the connecting portion 34a is connected to one end (basal end) of a rod-shaped metal terminal 37. The holder 23 holds the other end (distal end) of the metal terminal 37 to electrically insulate the metal terminal 37 and the metal cover 22 (connector coupler 22c). The metal terminal 37 is formed integrally with the holder 23 and thereby arranged integrally with the holder 23.

A U-shaped deformation portion 37a is formed between the basal and distal ends of the metal terminal 37. The metal terminal 37 is easily deformed from the deformation portion 37a. When the inverter cover 21, which is arranged integrally with the metal terminal 37 and the holder 23, is fixed to the suction housing 12, the basal end of the metal terminal 37 is connected to the connecting portion 34a.

The distal end of the metal terminal 37, which is exposed from the holder 23 in the connector coupler 22c, is electrically connected to a connection terminal (not shown) of a power supplying external connector 39 (indicated by double-dashed lines in FIGS. 1A and 1B), which is connected to the connector coupler 22c. This electrically connects the external connector 39 to the circuit board 20a via the metal terminal 37 and the connection terminal 33 and forms a structure for connecting the metal terminal 37 and the connection terminal 33. Accordingly, in the present embodiment, the metal terminal 37 and the connection terminal 33 form a lead 38 that electrically connects the circuit board 20a and the external connector 39. Further, the lead 38, the connector coupler 22c, and the holder 23 form a connector C1 that is connected to the external connector 39.

When the circuit board 20a is supplied with power from the external connector 39 through the metal terminal 37 and connection terminal 33 (i.e., lead 38), the drive control circuit of the circuit board 20a supplies power to the electric motor 16, rotates the rotor 18 and rotary shaft 19 at a controlled rotation speed, and drives the compression unit 15. As a result, the compression unit 15 draws refrigerant into the suction housing 12 through the suction port from the external refrigerant circuit, compresses the refrigerant in the suction housing 12 with the compression unit 15, and discharges the compressed refrigerant to the external refrigerant circuit through the discharge port 14.

The operation of the present embodiment will now be described.

When connecting the external connector 39 to the connector coupler 22c, a connection terminal of the external connector 39 is fitted to the metal terminal 37. This applies stress to the circuit board 20a through the metal terminal 37 and the connection terminal 33. Here, the rear surface of the circuit board 20a is supported by the supports 12c. Thus, the supports 12c receive the stress applied to the circuit board 20a. When disconnecting the external connector 39 from the connector coupler 22c, the removal of the connection terminal of the external connector 39 from the metal terminal 37 applies a force to the metal terminal 37 acting to pull the metal terminal 37 toward the external connector 39. This force is transmitted to the circuit board 20a through the metal terminal 37 and the connection terminal 33. However, in the present embodiment, the circuit board 20a is fastened by the bolts B1 to the supports 12c. Thus, the circuit board 20a is not pulled toward the external connector 39. Accordingly, in the present embodiment, the supports 12c and the bolts B1 form a stress dampening unit that dampens the stress applied to the circuit board 20a through the metal terminal 37 and the connection terminal 33 when the connection terminal of the external connector 39 is fitted to and removed from the metal terminal 37.

Further, the holder 23 integrally holds the metal terminal 37. Thus, when the connection terminal of the external connector 39 is fitted to and removed from the metal terminal 37, movement of the metal terminal 37 in the fitting and removal direction is restricted. Further, the application of stress to the circuit board 20a through the metal terminal 37 is suppressed. Thus, in the present embodiment, in addition to the supports 12c and the bolts B1, the holder 23 also functions as part of the stress dampening unit.

Moreover, when the connection terminal of the external connector 39 is fitted to and removed from the metal terminal 37, the deformation portion 37a deforms so that the stress acting on the circuit board 20a through the metal terminal 37 and the connection terminal 33 is subtle. Thus, in the present embodiment, the deformation portion 37a also functions as part of the stress dampening unit in addition to the supports 12c, the bolts B1, and the holder 23.

The above embodiment has the advantages described below.

(1) The holder 23 integrally holds the metal terminal 37 of the lead 38. Thus, when the connection terminal of the external connector 39 is fitted to or removed from the metal terminal 37, movement of the metal terminal 37 in the fitting and removing direction is restricted. This suppresses the application of stress applied to the circuit board 20a through the metal terminal 37.

(2) The deformation portion 37a is arranged in the metal terminal 37 of the lead 38 between the circuit board 20a and the holder 23. The deformation portion 37a deforms when the connection terminal of the external connector 39 is fitted to or removed from the metal terminal 37. Thus, the stress acting on the circuit board 20a through the metal terminal 37 and the connection terminal 33 is subtle. Further, the circuit board 20a and the holder 23 are each provided with a dimensional tolerance. Such dimensional tolerance is absorbed as the deformation portion 37a deforms when the metal terminal 37, which is held by the holder 23, is connected to the connecting portion 34a. This facilitates the connection of the metal terminal 37 and the connecting portion 34a.

(3) The stress dampening unit includes the supports 12c, which support the circuit board 20a from the rear side of the circuit board 20a, and the bolts B1, which fasten the circuit board 20a to the supports 12c. Since the rear surface of the circuit board 20a is supported by the supports 12c, when the external connector 39 is fitted to the lead 38, the supports 12c receive the stress applied to the circuit board 20a through the lead 38. Further, the circuit board 20a is fastened to the supports 12c by the bolts B1 and prevented from being pulled toward the external connector 39 when the external connector 39 is pulled off the lead 38. In this manner, the stress applied to the circuit board 20a through the lead 38 is dampened when the external connector 39 is fitted to and removed from the lead 38.

(4) The circuit board 20a and the solder bonding surface 35a of the second connection terminal portion 35 are soldered through a reflow process to electrically connect the circuit board 20a and the lead 38. For example, subsequent to the insertion of a lead into an insertion hole formed in the circuit board 20a, a soldering iron may be used to solder the circuit board 20a and the lead. In this case, soldering is performed on opposite sides of the circuit board with the soldering iron after the lead is inserted into the insertion hole of the circuit board 20a. In contrast, in the present embodiment, after applying the solder 40 to the front surface of the circuit board 20a, the solder bonding surface 35a of the second connection terminal portion 35 is arranged on the solder 40. Then, the circuit board 20a is arranged in a reflow furnace and heated. This solders the circuit board 20a and the solder bonding surface 35a of the second connection terminal portion 35. Thus, there is no need to perform soldering with a soldering iron on opposite sides of the circuit board 20a like when soldering the circuit board 20a and lead with a soldering iron. This reduces the soldering steps.

(5) The circuit board 20a is fixed to the supports 12c by fastening the bolts B1 to the threaded holes 121c of the supports 12c. Thus, the heat generated from the circuit board 20a can be radiated toward the suction housing 12 through the bolts B1 and the supports 12c.

(6) The inverter cover 21 is formed by the metal cover 22 in addition to the holder 23, the inner end insulator 24, the inner circumferential insulator 25, and the seal flange 26. At the same time as when the inverter cover 21 is fixed to the end wall 12a of the suction housing 12, the seal flange 26 is held between the metal cover flange 22d and the flange 12f. Thus, the seal flange 26 hermetically seals the gap between the end surface 222d of the metal cover flange 22d and the end surface 12e of the flange 12f just by fixing the inverter cover 21 to the suction housing 12. Accordingly, there is no need to provide a separate seal to seal the gap between the end surface 222d of the metal cover flange 22d and the end surface 12e of the flange 12f. This reduces the number of components and facilitates assembly.

(7) The metal terminal 37 of the lead 38 is arranged integrally with the holder 23. This ensures the hermetic seal between the metal terminal 37 and the holder 23.

### Second Embodiment

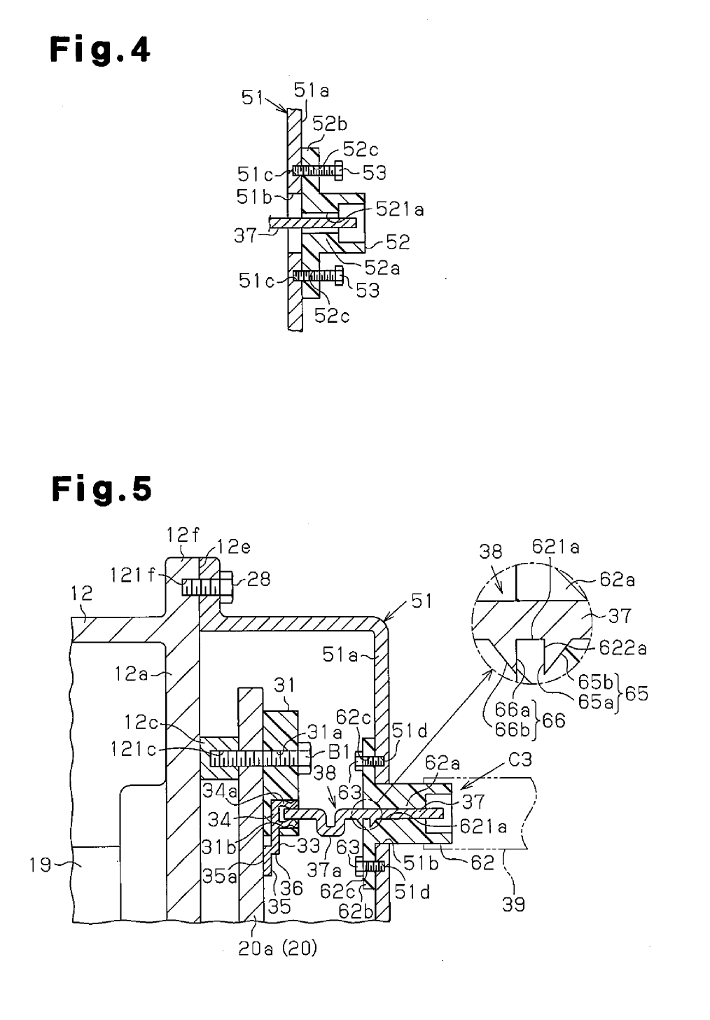

A second embodiment of the present invention will now be described with reference to FIGS. 3 and 4. In the description hereafter, like or same reference numerals are given to those components that are the same as the corresponding components of the first embodiment. Such components will not be described in detail.

Referring to FIG. 3, an inverter cover 51 is fixed to the end wall 12a of the suction housing 12. The inverter cover 51, which has one open side, accommodates the inverter (circuit board 20a). The inverter cover 51 is formed from aluminum. An insertion hole 51b extends through an end wall 51a of the inverter cover 51. The distal portion of the metal terminal 37 extends through the insertion hole 51b and out of the inverter cover 51. The outer surface of the end wall 51a includes two threaded holes 51c.

A resin connector coupler 52 is arranged on the inverter cover 51. The connector coupler 52 is coupled to the outer surface of the end wall 51a to close the insertion hole 51b. The connector coupler 52 includes a holder 52a, which holds the distal portion of the metal terminal 37, and a flange 52b, which is continuous with the holder 52a and extends outward along the outer surface of the end wall 51a from the holder 52a. The flange 52b includes two threaded holes 52c, which are aligned with the corresponding threaded holes 51c of the inverter cover 51. Bolts 53 are fastened to the threaded holes 52c of the flange 52b and the corresponding threaded holes 51c of the inverter cover 51 to fix the connector coupler 52 to the end wall 51a of the inverter cover 51.

The distal portion of the metal terminal 37 is held in a state sandwiched by part of the holder 52a. Referring to FIG. 4, before the distal portion of the metal terminal 37 is sandwiched by the holder 52a, the distal portion of the metal terminal 37 is held in a state extended through an insertion hole 521a of the holder 52a. When coupling the connector coupler 52 to the end wall 51a of the inverter cover 51, as the bolts 53 are fastened to the threaded holes 52c of the flange 52b, a spring (not shown) arranged in the holder 52a urges part of the holder 52a to fill the gap between the wall of the insertion hole 521a and the metal terminal 37. As a result, the distal portion of the metal terminal 37 is held in a state sandwiched by part of the holder 52a. In this manner, in the present embodiment, the lead 38 and the connector coupler 52 form a connector C2, which is connected to the external connector 39.

The operation of the second embodiment will now be described.

When connecting the external connector 39 to the connector coupler 52, the connection terminal of the external connector 39 is fitted to the metal terminal 37. This applies force to the metal terminal 37 acting to move the metal terminal 37 toward the circuit board 20a along the fitting and removing direction. However, the distal portion of the metal terminal 37 is held in a state sandwiched by the holder 52a. This restricts movement of the metal terminal 37 toward the circuit board 20a along the fitting and removing direction. Further, when the connection terminal of the external connector 39 is removed from the metal terminal 37, force is applied to the metal terminal 37 acting to pull the metal terminal 37 toward the external connector 39. However, the distal portion of the metal terminal 37 is held in a state sandwiched by the holder 52a. This restricts movement of the metal terminal 37 toward the external connector 39 along the fitting and removing direction. In this manner, in the second embodiment, in addition to the supports 12c and the bolts B1, the holder 52a also functions as part of the stress dampening unit.

In addition to advantages (1) to (5) and (7) of the first embodiment, the second embodiment has the following advantage.

(8) The metal terminal 37 of the lead 38 is held in a state sandwiched by the holder 52a. This increases the holding force applied by the holder 52a to the metal terminal 37. Thus, when the external connector 39 is fitted to and removed from the metal terminal 37, movement of the metal terminal 37 in the fitting and removing direction is further easily restricted.

### Third Embodiment

A third embodiment of the present invention will now be described with reference to FIG. 5.

Referring to FIG. 5, an inverter cover 51, which is similar to that of the second embodiment, is fixed to the end wall 12a of the suction housing 12. The inner surface of the end wall 51a of the inverter cover 51 includes two threaded holes 51d.

A resin connector coupler 62 projects out of the inverter cover 51 from the insertion hole 51b. The connector coupler 62 includes a holder 62a, which holds the distal portion of the metal terminal 37, and a flange 62b, which is continuous with the holder 62a and extends outward along the inner surface of the end wall 51a from the holder 62a. The flange 62b includes two threaded holes 62c, which are aligned with the corresponding threaded holes 51d of the inverter cover 51. Bolts 63 are fastened to the threaded holes 62c of the flange 62b and the corresponding threaded holes 51d of the inverter cover 51 to fix the connector coupler 52 to the end wall 51a of the inverter cover 51. The holder 62a includes an insertion hole 621a into which the distal end of the metal terminal 37 can be inserted.

As show by the enlarged view in FIG. 5, a first hook 65 and a second hook 66 extend from the outer surface of the metal terminal 37. The first and second hooks 65 and 66 can be hooked to the holder 62a. The first hook 65 is located closer to the distal end of the metal terminal 37 than the second hook 66.

The first hook 65 includes a first hooking surface 65a, which extends in a direction perpendicular to the axial direction of the metal terminal 37, and a first insertion surface 65b, which connects the first hooking surface 65a to the outer surface of the metal terminal 37 and is inclined toward the distal end of the metal terminal 37 from the first hooking surface 65a. The second hook 66 includes a second hooking surface 66a, which extends in a direction perpendicular to the axial direction of the metal terminal 37, and a second insertion surface 66b, which connects the second hooking surface 66a to the outer surface of the metal terminal 37 and is inclined toward the basal end of the metal terminal 37 from the second hooking surface 66a.

The distal portion of the metal terminal 37 is forcibly inserted into the insertion hole 621a of the holder 62a from the side of the first insertion surface 65b. This hooks the first hooking portion 65 to a hooked recess 622a, which is formed in the wall surface of the insertion hole 621a. Further, the second hooking surface 66a of the second hook 66 is hooked to the surface of the holder 62a facing toward the circuit board 20a. This holds the metal terminal 37 in a state hooked to the holder 62a. In the present embodiment, the lead 38 and the connector coupler 62 form a connector C3, which is connected to the external connector 39.

The operation of the third embodiment will now be described.

When connecting the external connector 39 to the connector coupler 62, the connection terminal of the external connector 39 is fitted to the metal terminal 37. This applies force to the metal terminal 37 acting to move the metal terminal 37 toward the circuit board 20a along the fitting and removing direction. However, the first hooking surface 65a of the first hook 65 is hooked to the hooked recess 622a in the wall surface of the insertion hole 621a. This restricts movement of the metal terminal 37 toward the circuit board 20a along the fitting and removing direction. Further, when the connection terminal of the external connector 39 is removed from the metal terminal 37, force is applied to the metal terminal 37 acting to pull the metal terminal 37 toward the external connector 39. However, the second hooking surface 66a of the second hook 66 is hooked to the surface of the holder 62a facing toward the circuit board 20a. This restricts movement of the metal terminal 37 toward the external connector 39 along the fitting and removing direction. In this manner, in the third embodiment, the first hook 65, the second hook 66, and the holder 62a also function as part of the stress dampening unit in addition to the supports 12c and the bolts B1.

In addition to advantages (1) to (5) and (7) of the first embodiment, the third embodiment has the advantages described below.

(8) The metal terminal 37 of the lead 38 includes the first and second hooks 65 and 66 that can be hooked to the holder 62a. The first and second hooks 65 and 66, which are hooked to the holder 62a, restricts movement of the metal terminal 37 in the fitting and removing direction when the external connector 39 is fitted to and removed from the metal terminal 37. This suppresses the application of stress to the circuit board 20a through the lead 38.

It should be apparent to those skilled in the art that the present invention may be embodied in many other specific forms without departing from the spirit or scope of the invention. Particularly, it should be understood that the present invention may be embodied in the following forms.

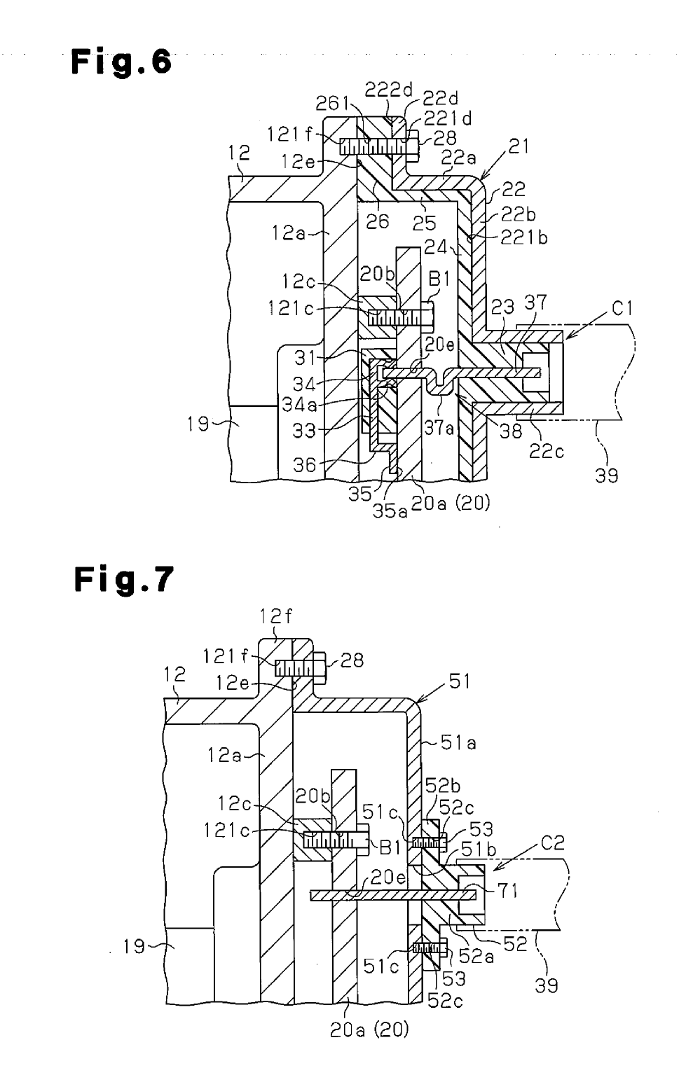

Referring to FIG. 6, the resin connector 31 may be coupled to the rear surface of the circuit board 20a. As shown in FIG. 6, the metal terminal 37 is extended through an insertion hole 20e formed in the circuit board 20a and includes one end connected to the connecting portion 34a. This allows the space between the inverter cover 21 and the circuit board 20a to be minimized. In this case, the inner end insulator 24 is required to ensure insulation between the metal cover 22 and the circuit board 20a.

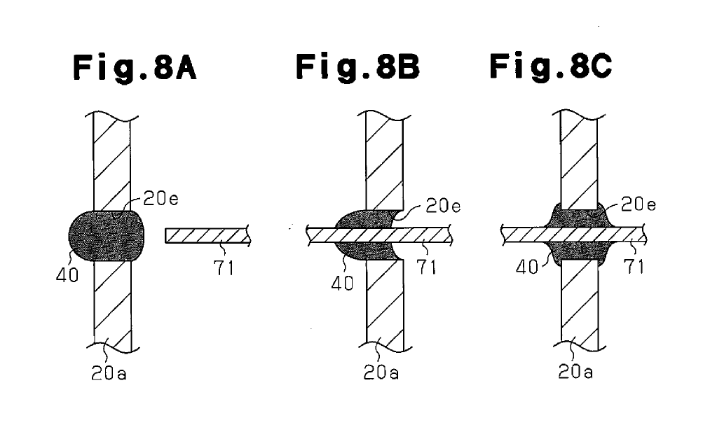

In the above embodiments, a reflow process is performed to solder the circuit board 20a and the solder bonding surface 35a of the second connection terminal portion 35 to electrically connect the circuit board 20a and the lead 38. However, the present invention is not limited in such a manner. For example, as shown in FIG. 7, one end of a straight rod-shaped lead 71 may be inserted into an insertion hole 20e formed in the circuit board 20a, and a reflow process may be performed to solder the circuit board 20a and the lead 71. More specifically, as shown in FIG. 8A, solder 40 is first filled in the insertion hole 20e of the circuit board 20a. Then, as shown in FIG. 8B, one end of the lead 71 is extended through the solder 40 in the insertion hole 20e. As the lead 71 advances through the solder 40, the solder 40 is entirely moved in the direction the lead 71 is inserted. Subsequently, the circuit board 20a is arranged in a reflow furnace and heated to a maximum temperature of approximately 260° C. As shown in FIG. 8C, the solder 40, which has been moved in the insertion direction of the lead 71, is moved by surface tension along the wall surface of the insertion hole 20e into the space between the outer surface of the lead 71 and the insertion hole 20e. Then, the solder 40 is cooled and solidified thereby soldering the circuit board 20a and the lead 71. Afterward, as shown in FIG. 7, the bolts B1 fasten the circuit board 20a to the supports 12c, and the inverter cover 51 is coupled to the end wall 12a of the suction housing 12. Further, the connector coupler 52 is coupled to the outer surface of the end wall 51a of the inverter cover 51 to cover the insertion hole 51b of the inverter cover 51. In this state, the distal portion of the lead 71 is held in a state sandwiched by part of the holder 52a.

In the above embodiments, the supports 12c do not have to support the circuit board 20a from the rear surface of the circuit board 20a, and the bolts B1 do not have to fasten the circuit board 20a to the supports.

In the above embodiments, the deformation portion 37a may be omitted.

In the above embodiments, the metal terminal 37 does not have to be held by the holders 23, 52a, and 62a.

In the above embodiments, the inverter covers 21 and 51 may entirely be formed from a resin.

In the above embodiments, the external connector 39 does not have to be used to supply power and may be used, for example, to output signals of a sensor.

The present invention is embodied in a structure for connecting the external connector 39 and the circuit board 20a, which drives and controls the electric motor 16 installed in an electric compressor 10.

The present examples and embodiments are to be considered as illustrative and not restrictive, and the invention is not to be limited to the details given herein, but may be modified within the scope and equivalence of the appended claims.

1. A structure for connecting a circuit board and an external connector, the structure comprising:
a lead that electrically connects the circuit board and the external connector, wherein the external connector is fitted to and removed from the lead; and
a stress dampening unit that dampens stress applied to the circuit board by the lead when the external connector is fitted to and removed from the lead.

2. The structure according to claim 1, further comprising:
a housing that accommodates a drive unit driven when supplied with power from the circuit board;
a cover fixed to the housing, wherein
the cover accommodates the circuit board,
the cover includes a connector coupler, which is connected with the external connector, and a holder, which integrally holds the lead,
the external connector is connected to the connector coupler to electrically connect the external connector to the lead, and
the holder functions as the stress dampening unit.

3. The structure according to claim 2, wherein the lead is held in a state sandwiched in the holder.

4. The structure according to claim 2, wherein the lead includes a hook hooked to the holder, and the hook functions as the stress dampening unit.

5. The structure according to claim 2, wherein the lead includes a deformation portion located between the circuit board and the holder.

6. The structure according to claim 1, wherein
the circuit board includes a first surface and an opposite second surface,
the lead extends from the first surface of the circuit board to a portion connected to the external connector, and
the stress dampening unit includes
a support supporting the second surface of the circuit board, and
a fastener fastening the circuit board to the support.

7. The structure according to claim 1, wherein the circuit board and the lead are soldered through a reflow process and electrically connected.

8. A connector comprising:
a lead that electrically connects a circuit board and an external connector, wherein the external connector is fitted to and removed from the lead;
a connector coupler connected with the external connector; and
a stress dampening unit that dampens stress applied to the circuit board by the lead when the external connector is fitted to and removed from the lead.
